(19) United States
(12) Patent Application Publication
(10) Pub. No.: US 2023/0294535 A1
(43) Pub. Date: Sep. 21, 2023

(54) CHARGING BEACON

(71) Applicant: Rivian IP Holdings, LLC, Irvine, CA (US)

(72) Inventors: Sara Eslinger, Redwood City, CA (US); Tyler Erikson, Torrance, CA (US); Elizabeth K. Steenwyk, Detroit, MI (US)

(21) Appl. No.: 17/696,001

(22) Filed: Mar. 16, 2022

(51) Int. Cl. B60L 53/30; H02J 7/00; B60L 58/12

(52) U.S. Cl. CPC B60L 53/305; B60L 58/12; H02J 7/00032; H02J 7/0048

(57) ABSTRACT

Systems and methods are provided that provide for receiving a notification of a vehicle to be charged by a charging station having a plurality of chargers. Information identifying a first one of the plurality of chargers may be communicated to the vehicle in response to the notification. Example systems for charging vehicles via a plurality of chargers may include a processor configured to receive a notification of a vehicle approaching a charging station comprising the plurality of chargers. The processor may also be configured to determine a first one of the plurality of chargers for charging the vehicle. The system may also include a first visual identifier located at a first one of the plurality of chargers. The processor may be configured to activate the selective visual identifier to communicate the first one of the plurality of chargers to the vehicle.

### INTRODUCTION

The present disclosure is directed to a charging system for a vehicle, and more particularly to a charging system for a vehicle that is configured to communicate a charger status or other information to an approaching vehicle.

### SUMMARY

At least some example illustrations herein are directed to a method that includes receiving a notification of a vehicle to be charged by a charging station or site having a plurality of chargers. The method also includes communicating information identifying a first one of the plurality of chargers to the vehicle in response to the notification.

In at least some example illustrations, a system for charging vehicles via a plurality of chargers is provided. The system includes a processor configured to receive a notification of a vehicle to be charged by a charging station comprising the plurality of chargers. The processor is also configured to determine a first one of the plurality of chargers for charging the vehicle. The system also includes a first visual identifier located at a first one of the plurality of chargers. The processor is configured to activate the selective visual identifier to communicate the first one of the plurality of chargers to be used.

At least some example illustrations are directed to a system for charging vehicles via a plurality of chargers. The system comprises a processor configured to receive a notification of a vehicle to be charged by a charging site comprising the plurality of chargers. The processor is also configured to determine a first one of the plurality of chargers for charging the vehicle. The system also includes a first visual identifier located at a first one of the plurality of chargers, and a second visual identifier located at a second one of the plurality of chargers. The processor is configured to activate one of the first visual identifier or the second visual identifier to the vehicle to identify the first one of the plurality of chargers to be used.

### BRIEF DESCRIPTION OF THE DRAWINGS

The above and other features of the present disclosure, its nature and various advantages will be more apparent upon consideration of the following detailed description, taken in conjunction with the accompanying drawings in which:

FIG. 1 shows a perspective view of an illustrative charging device having a visual identifier, in accordance with some embodiments of the present disclosure;

FIG. 2 shows a schematic view of a vehicle charging system powering multiple charging devices, such as the charging device of FIG. 1, where the charging devices draw electrical power from multiple sources, in accordance with some embodiments of the present disclosure;

FIG. 3 illustrates a table of example information that may be communicated by way of visual identifiers of charging devices, e.g., as illustrated in the system of FIG. 2, in accordance with some embodiments of the present disclosure;

FIG. 4 illustrates a strategy for coordinating visual identifiers of multiple charging devices in the system of FIG. 2, in accordance with some embodiments of the present disclosure;

FIG. 5A illustrates an example strategy for determining a charging device for vehicle(s) approaching the system of FIG. 2 based at least in part upon vehicle characteristics, according to an example approach;

FIG. 5B illustrates another example strategy for determining a charging device for vehicle(s) approaching the system of FIG. 2 based at least in part upon system characteristics, according to an example approach; and

FIG. 6 shows a flowchart of an illustrative process for determining an appropriate charging device for a vehicle approaching a charging system, in accordance with some embodiments of the present disclosure.

### DETAILED DESCRIPTION

Battery-electric vehicles generally have one or more battery packs configured to store electrical energy, and which provide electrical power to motor(s) of the vehicle for propulsion. Charging systems have been developed and installed at various locations in an effort to provide opportunities for recharging during longer journeys. The charging systems typically include a charger configured to be plugged into a vehicle to recharge a vehicle battery pack.

It may be advantageous for a user to know what chargers will provide the fastest charge for a vehicle. However, charging speed and capacity of a charger may be dependent uponseveral unseen factors, such as the extent to which the vehicles already at a charging station are approaching completion of a charging cycle. Additionally, some chargers may share electrical power such that available power is split between multiple chargers in the event multiple cars are plugged in at the same time. Further, a user may not know if a charger or charging station is broken or otherwise suffering from degraded capabilities until attempting. Some charging stations or chargers may also be difficult to locate, e.g., across a large parking lot, at night, etc.

Accordingly, example illustrations herein are generally directed to charging systems and methods that identify or communicate a particular charger to a vehicle/customer. Example chargers may have lighting or other indicators that are activated to visually identify a charger. The lighting may be distinctive to facilitate identifying a charger among a number of different chargers and/or call attention to the charger across a large parking lot or area. Merely as examples, the lighting may include different colors, movement or flashing to help distinguish an identified charger. Accordingly, lighting may generally call visual attention to a given charger to facilitate identifying the charger to an approaching vehicle or customer.

Example lighting or visual indicators may be employed to communicate information about a charger. Accordingly, information relevant to the customer experience as determined from one or more factors may be made evident in real time. These factors may include parameters or characteristics of a charger or charging station, such as an availability of the charger, charging/electrical capacity, or a charging speed available at the charger. Additionally, to the extent attributes on the vehicle side are available such as state of charge, proximity to a charging location or charger, etc., this information can also be used to enhance the customer experience. Merely by way of example, to the extent a state of charge of a vehicle plugged into a charger is known, the system may be able to determine how soon the charger will be available for another vehicle/customer. Additionally, a state of charge of one or more vehicles approaching a charge station may be used to allocate the vehicles to different chargers at a location. In examples below, vehicles may be allocated to yield the an optimized charging load profile and/or customer experience.

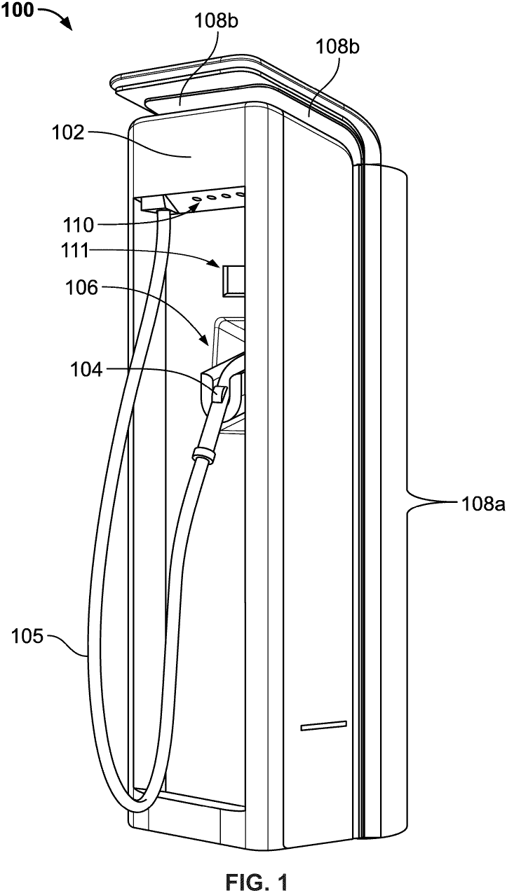

Turning now to FIG. 1, an example charger or charging device 100 is illustrated and described in further detail. The device 100 is configured to supply electrical current, e.g., a high-speed direct current, to a battery-electric vehicle (not shown in FIG. 1) for recharging a battery pack. The device 100 includes a main body 102 and a plug or connector 104, e.g., that is configured to be inserted into a corresponding charging receptacle or port of the vehicle. Charging device 100 is illustrated with the connector 104 inserted into a holder or receptacle 106, in which the connector 104 may remain when not actively charging a vehicle. The connector 104 conducts electricity from a cable 105. Generally, the body 102 is positioned at or adjacent a charging stall, parking spot, bay, or other location where a vehicle may be positioned to facilitate reach of the connector 104 to the vehicle receptacle.

The charging device 100 may include one or multiple visual identifiers. In the example illustrated in FIG. 1, the charging device 100 includes visual identifier 108 as a light bar extending alongside and upper portions of the body 102. Accordingly, the visual identifier 108 includes a side portion 108a extending along a side of the body 102. The side portion 108a extends continuously from a lower portion of the body 102 upwardly to an upper portion 108b, which extends along a front/upper portion of the body 102. The visual identifier 108 may include multiple light-emitting diodes (LEDs), bulbs, or other lighting devices. In the example illustrated, the visual identifier 108 is configured to provide a plurality of colors, a plurality of levels of brightness or intensity, and a plurality of movements, pulsing patterns, or the like. Accordingly, as will be discussed further below, the visual identifier 108 is configured to provide individualized identification to others approaching or near a charging system employing one or more chargers 100.

The charging device 100 may also include a user light 110, which generally casts light downward from an upper part of the main body 102, e.g., to cast ambient light onto the charging device 100 and/or upon a ground surface adjacent the charging device 100. Accordingly, the user light 110 facilitates use of the charging device 100 during nighttime hours or when ambient lighting around the charging device 100 is minimal or unavailable. A display 111 may also be provided for communicating with a user of the charging device 100, e.g., to provide instructions for use, indicate electrical power provided to a vehicle that is plugged in to the charging device 100, or the like.

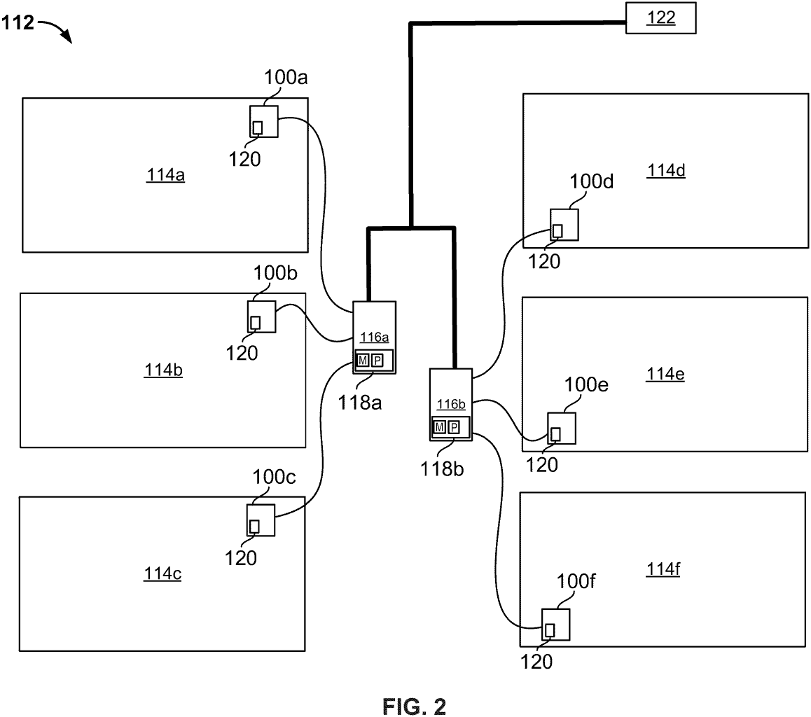

Referring now to FIG. 2, a charging system 112 is illustrated, which employs a plurality of charging devices 100a, 100b, 100c, 100d, 100e, and 100f (collectively, 100). The charging devices 100 are positioned to provide electrical power to a corresponding plurality of bays or stalls 114a, 114b, 114c, 114d, 114e, and 114f (collectively, 114). It should be understood that while six charging devices 100 and corresponding bays 114 are illustrated in FIG. 2, this is merely illustrative and any number of charging devices 100 and/or bays 114 may be provided. The charging devices 100a, 100b, and 100c are supplied electrical power via a shared power source or charging source 116a, while the charging devices 100d, 100e, and 100f are each supplied electrical power via a separate source 116b. The source(s) 116 may configured to provide power to the charger(s) 100, and may also translate AC power supplied to the shared source 116 to DC power, using for example, one or more power modules. In an example, the source 116 is a Power Cabinet. The sources 116 may each be configured to supply a maximum amount or rate of power to their respective charging devices 100. Moreover, the sources 116 may each be configured to divide electrical power amongst the charging devices 100. In some examples, source 116a may provide 100% of its available power to a single vehicle in one of its associated bays 114 via charging device 100. Alternatively, when multiple vehicles are drawing power from the charging devices 100a, 100b, and/or 100c, the source 116a may divide power supply between the multiple vehicles in any manner that is convenient. As will be discussed further below, the sources 116 may be configured to split or divide available electrical power unequally between different charging devices 100 using, for example, one or more power modules associated with the sources 116. Electrical equipment, e.g., switch gear, a utility transformer, or the like, may be provided to supply AC power to the shared source(s) 116 such as from a utility grid.

The sources 116 and chargers 100 may generally be controlled via one or more controllers of the sources 116 and/or chargers 100, and may be in communication with a central office or control 122, e.g., via switch gear or other common electrical gear. Accordingly, the charging devices 100 may be controlled, e.g., to apportion electrical power supplied via the charging system 112, sources 116, and/or charging devices 100.

In the example illustrated in FIG. 2, each of the sources 116 includes a controller 118 including a processor (M) and memory (P). The memory may be a computer-readable storage medium or the like configured to store instructions which cause the processor to perform example methods discussed further below, or steps thereof. The controllers 118 may be in communication with the central office 122, which may be in communication with other charging systems (not shown in FIG. 1). The central office 122 may also communicate with the system 112 to provide updates, control operational aspects of the system 112, or the like.

Generally, each controller 118 may govern certain operating aspects of its respective source 116, e.g., as discussed further below. The controller 118 may also be in communication with a controller 120 of each respective charger 100. The controllers 120 may each include a processor and/or memory comprising a computer-readable storage medium or the like configured to store instructions which cause the associated processor to perform example methods discussed further below, or steps thereof. In an example, the controller 118 is a power cabinet control unit (PCU) and the controller 120 is a dispenser control unity (120). Generally, the controller 120 may activate visual identifier(s) 108 of the charging devices 100, e.g., to notify users or vehicles approaching the system 112 of a status of charging device(s) 100, a selection of a charging device 100 for a given vehicle/user, or the like. For example, a notification may be received of a vehicle approaching the charging system 112, and the controller 118 may determine an appropriate charging device 100 for the vehicle to use for charging. The controller 118 may, in response, activate a visual identifier located at the determined charging device 100 by notifying a respective controller 120 of the charger 100. For example, the controller 120 may activate visual identifier 108, e.g., with a particular color, flashing pattern, etc. Accordingly, the identified charging device 100 is identified to the vehicle by the activation of the visual identifier 108, allowing the vehicle and its driver to drive directly to the indicated charging device 100.

As will be discussed further below, a charging device 100 may be selected or determined based upon a variety of factors. In some examples, the processors 118 and/or 120 are configured to determine a charging device 100 from those available based upon a vehicle state of charge. In some examples, the processors 118/120 may select a charging device 100 based upon a charging capacity of one or more of the charging devices 100. For example, charging capacities of different charging devices 100 and/or sources 116 may be compared to determine an appropriate one of the charging devices 100 to select for an approaching vehicle.

In some examples, the controller 118 of the source 116 may direct other operational aspects of the source 116 and associated chargers 110. For example, the controller 118 generally implements communication and control of the source 116, e.g., by providing for communication of the source 116 with central office 122 and/or chargers 100 connected to the source 116.

The controller 120 may also facilitate a “cable check” upon arrival of a vehicle seeking recharging at the system 112, e.g., to identify one or more available chargers 100 for the vehicle. The controller 120 may also coordinate a pre-charging state of the chargers 100 of a given source 116, e.g., in preparation for supplying charging power via the chargers 100. The controller 118 may also coordinate current demand among chargers 100 of a source 116, e.g., to inform an assigned charger 100 or components thereof of a current export target, optimize efficiency based on an expected performance curve, etc. The controller 118 may also allocate power modules to the chargers 100 to which the source 116 is connected. Power module allocation may be based on the number of vehicles plugged in and the power curve of each of those vehicles. This allocation may be learned over time, including predictive plug-in events, and may utilize stored profiles for vehicles using the system 112 to tune power sharing for charging time optimization. The controller 118 may also facilitate the end of a charging session of a vehicle, e.g., by causing power modules to gradually reduce current to zero as the charging session reaches a conclusion, and/or by performing an internal welding check of contactors of the source 116. Further, controller 118 may control a cooling system of the source 116, e.g., including a fan or other devices for circulating coolant or air to control operating temperatures of any components of the source 116. Accordingly, power modules may be kept within an ideal operating temperature or humidity range, e.g., by controlling a speed of a radiator fan of the source 116, logging faults within a cooling pump, fan, or a coolant leak, and/or by communicating a power derating of the source 116 in response to elevated temperatures. The controller 118 may also control an alternating-current (A/C) Ground Fault Circuit Interruption (GFCI) of the source 116. For example, a GFCI device alarm may be activated by the controller 118 when a ground fault is detected. Additionally, the controller 118 may log the occurrence of the fault, e.g., in the memory of the controller 118, and/or may take preventative action such as opening a main A/C circuit breaker of the source 116. The controller 118 may also implement an interlock control to deactivate the source 116 in response to certain conditions where continued operation of the source 116 and/or associated chargers 110 may not be desired. A charger 100 may, for example, deactivate or trip, or a power fault of the source 116 may occur, or a switch of the source 116 may open during a charging session or while the source 116 and/or chargers 100 are in a standby state. The controller 118 may also monitor and respond to surge events, e.g., by suppressing a voltage surge event and/or logging or communicating the events to the central office 122.

The controller 120 of the charger(s) 100 may generally control operating aspects of the charger(s) 100, or communication with source 116. The controller 120 may also provide a communication interface with a vehicle (not shown in FIG. 2) being charged by a charger 100, e.g., via a standardized communication protocol such as J1772. The controller 120 may also negotiate direct-current (D/C) charging with the vehicle. The controller 120 may interface with a current shunt module of the charger 100, which may use a controller-area network (CAN) to communicate with controller 118 of the source 116. Generally, the current shunt module (CSM) may measure D/C current and voltage, and may determine energy exported by the charger 100. The controller 120 may also control the screen 111, e.g., to relay information to a user about their session. Merely by way of example, regulatory requirements with respect to displaying pricing and/or amount of energy exported may be fulfilled by displaying via the screen 111. The controller 120 may also generally control activation of the visual indicator 108 of the charger 100, e.g., as described herein with respect to colors and/or movement patterns that may be displayed. The controller 120 may also activate user light 110 of the charger 100. The controller 120 may, in addition, control a cooling system of the charger 100, e.g., by interfacing with a coolant pump to turn the pump on/off, monitor cooling system temperatures/pressures and actuating corresponding alarms to the controller 118 and/or central office 122. The controller 120 may also provide an interlock control of the charger 100, e.g., by communicating faults of the charger 100 to the controller 120 of the source 116, thereby facilitating an emergency stop of the charger 100 and/or source 116. The controller 120 may communicate with controller 118 and/or central office 122 via a standardized protocol, e.g., open charge alliance OCPP or the like, or via a platform-specific protocol.

As noted above, the visual identifiers 108 of the charging devices 100 may be selectively activated with a particular color or other distinguishing characteristic, allowing an incoming vehicle or user to identify an appropriate charging device 100. A vehicle or user may select a particular color to be activated at the identified charging device 100, for example. In such cases, a vehicle or its driver may select a color, flashing pattern, or other distinguishing visual trait of the visual identifier 108, which may then be communicated to the controllers 118/120 and/or central office 122. The controllers 118/120 and/or central office 122 may activate the visual identifier 108 of the selected charging device 100 with the color selected by the approaching vehicle. In other examples, the controllers 118/120 and/or central office 122 may select a distinguishing visual trait such as color, flashing pattern, or the like, and communicate the distinguishing visual trait to be activated at the identified charging device 100 to the incoming vehicle. As noted above, the visual identifiers 108 of each of the charging devices 100 may be configured to display a plurality of different colors, such that each is capable of being activated with similar or different colors or other visual traits, as may be convenient.

Visual effects communicated by way of the visual identifiers 108 of the charging devices 100 may also be used to communicate characteristics of the charging devices 100. For example, the visual identifiers 108 of the charging devices 100 may be lit with a color representing a status of the charging device 100. The visual identifier 108 may include multicolor bulbs, light-emitting diodes (LEDs), display screens, or any other lighting devices that can provide multiple colors, brightness, etc. to facilitate activation of different colors, flashing, movement, etc. The various colors may be used to communicate information, e.g., as described below. Additionally, to the extent the visual identifier 108 is capable of providing various colors, changes in the visual identifier 108 between colors and/or brightness levels may be effected gradually. In one example, visual identifier 108 is transitioned from one color to another gradually, with a variety of shades in between a beginning and starting color, to avoid a more sudden or abrupt change in color. In another example, as ambient light present at a charging system 112 and/or charging device 100, visual identifier 108 may change gradually between colors or brightness levels. For example, visual identifier 108 may gradually transition from a relatively brighter or higher intensity employed during daytime hours (to achieve sufficient visual contrast) to a lower brightness/intensity at sundown and ambient light fades.

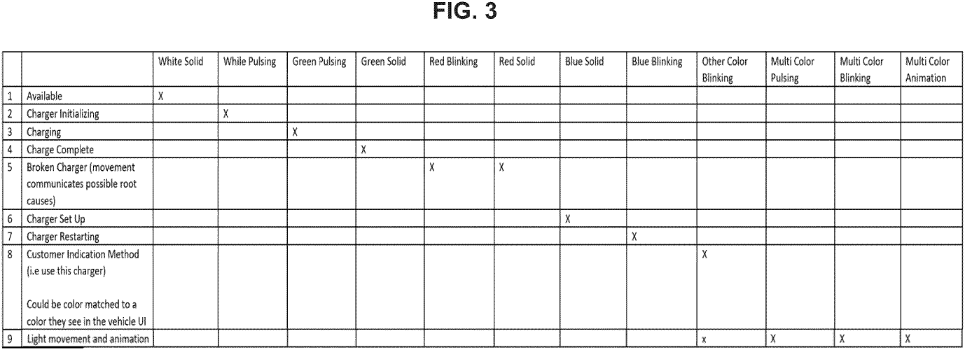

Turning now to FIG. 3, an example color and movement-based light activation strategy is illustrated as a table. More specifically, the table shows different colors and light characteristics, e.g., solid or flashing/blinking, with each corresponding to specific information to be indicated by the color/characteristic. Accordingly, the visual identifiers 108 of the charging devices 100 may indicate various conditions of a charging device 100 or otherwise provide information to users and/or approaching vehicles. The particular colors/light characteristics and information are merely exemplary, and accordingly it should be understood that other colors/characteristics of a lighting device may be used, and that other information may be communicated by way of the visual identifier 108.

As shown in FIG. 3, in this example, a visual identifier 108 of a charging device 100 indicates that it is available for charging when lit with a solid (i.e., non-pulsing or non-flashing) white color. Activation of the visual identifier 108 with a same or similar white-colored light that is flashing or pulsing, on the other hand, indicates that a charging device 100 is initializing, i.e., is in a process of activation (and thus the charging device 100 is not yet ready to charge a vehicle).

In the example illustrated in FIG. 3, activation of the visual identifier 108 with a green-colored light provides information relating to a charging status of a vehicle that is plugged in to the charging device 100, e.g., via the connector 104. More specifically, the visual identifier 108 may flash or pulse with a green color while the vehicle is charging but is not yet fully charged. Upon the vehicle reaching a desired charge level, e.g., 100% charge, the green light of the visual identifier 108 may stop flashing/pulsing, such that the visual identifier 108 is activated with a steady or solid green light.

A red color of the visual identifier 108 may indicate a problem or malfunction of a charging device 100 or other component of the system 112. For example, activation of the visual identifier 108 with a solid red light may indicate that the charging device 100 is not functioning or is otherwise unavailable. Further, a flashing/pulsing or movement of the visual identifier 108 while lit with a red color may provide information regarding a particular problem with the charging device 100. For example, flashing of the visual identifier in a specific area of the charging device 100 may indicate that a component of the charging device 100 in the same area where the flashing/movement of the visual identifier 108 is occurring is a cause of the problem.

A blue color of the visual identifier 108 may relate to system information relating to the charging device 100. For example, as illustrated in FIG. 3 a solid blue light of the visual identifier 108 may indicate that the charging device 100 is in a set-up process, e.g., receiving an over-the-air update from system 112. A flashing blue light of the visual identifier 108 may indicate the charging device 100 is starting up, restarting, or otherwise will be available comparatively shortly.

As also indicated in FIG. 3, any other colors may be employed to indicate other information. For example, a color not otherwise listed in the table of FIG. 3 may be associated with an approaching vehicle to help guide a driver of the vehicle to an appropriate charging device 100. In an example of this arrangement, a driver of an approaching vehicle is informed by the system 112 or command center 122 to proceed to a single charging device 100 amongst others nearby, with the visual identifier 108 of the selected charging device 100 activated with a specific color (e.g., orange) or with multiple colors (e.g., one half of the visual identifier 108 orange, and the other half of the visual identifier blue).

Generally, movement or flashing of visual identifier(s) 108 of one or more charging devices 100 in a system 112 may be used to draw visual attention. For example, visual identifier(s) 108 may use “chirping” or blinking to help a user to more easily find a charging device 100 and/or the system 112 in a large parking lot.

In addition to communicating information about vehicles and/or charging devices, visual identifiers 108 may be used to provide personality, e.g., to reflect colors of a holiday, or enable “easter egg” features to be found by users or passerby.

Accordingly, various colors, flashing or pulsing variations, and/or movement of the visual identifier 108 may be employed to dynamically communicate information in real time to help customers or users of a charging system 112, or to provide desired aesthetics in the charging system 112.

At a given time in the example charging system 112, multiple visual identifiers 108 in the system 112 may be activated with a similar appearance, e.g., a same or similar color, flashing pattern, or the like. It may be desirable to synchronize or coordinate appearance of the visual identifiers 108 of different charging devices 100. For example, where multiple vehicles are charging at corresponding charging devices 100, each charging device 100 may turn on and off simultaneously. In this manner, the visual identifiers 108 of the system 112 are coordinated.

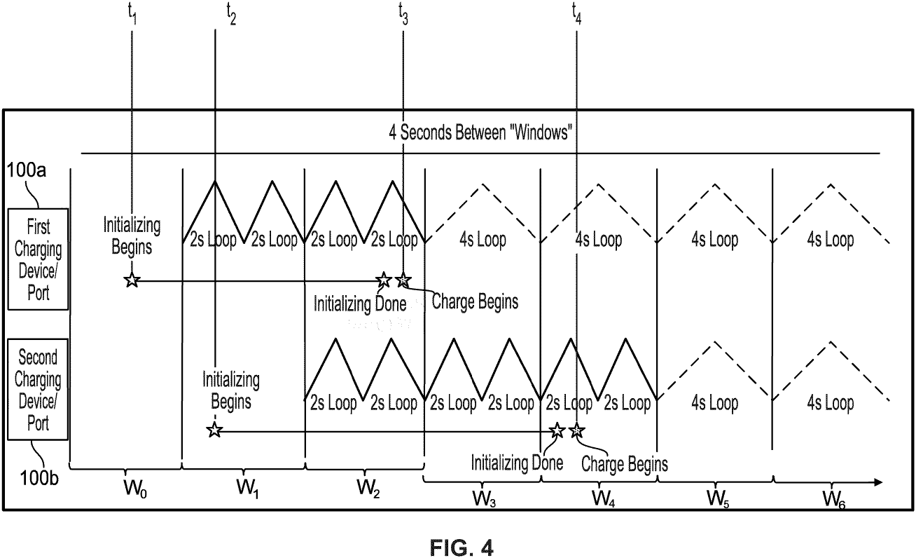

In some examples, the visual identifiers 108 may be detectable by the vehicle (e.g., using a camera or other imaging device) in addition or in alternative to being detectable by the user. For example, visual identifier 108 may be configured to communicate information to the vehicle by flashing at a specific frequency or pattern that the vehicle may detect and interpret. In such examples, the vehicle may communicate this information to the vehicle user using, for example, a vehicle display. As an illustrative example with reference to FIG. 3, the flashing blue light of the visual identifier 108 may indicate to the user that the charging device 100 is restarting, while the frequency of the flashing of the blue light may communicate additional information to the vehicle, such as the estimated time remaining for the restarting process. In this example, the vehicle may communicate the estimated time remaining to the user using, for example, a vehicle display (e.g., showing a view of vehicle camera augmented with the estimated time remaining).Referring now to FIG. 4, an example strategy for coordinating movements or flashing of visual identifiers 108 of multiple charging devices 100 is illustrated and described in further detail. Generally, the strategy employs coordinated or synchronized time windows, from which variations in light intensity, flashing, movement, or other effects of visual identifiers 108 are referenced. In this manner, appearance of visual identifiers 108 are unified or synchronized. Accordingly, if multiple charging devices 100 in a given system 112 are actively charging but all started at slightly different times, visual effects such as pulsing, flashing, movement, or the like generally occurs simultaneously, providing a more intentional and/or coordinated appearance.

In the example illustrated, a first vehicle is plugged into a first charging device 100a at time t₁, while a second vehicle is plugged into a second charging device 100b at time t₂. The charging devices 100 may, upon the vehicles being plugged into the device, execute an initialization process, e.g., where the charging device 100 determines a power level or current to be supplied for charging, or the like. In the example illustrated in FIG. 4, windows of four (4) seconds are employed, although this is merely an example and any other length of time may be employed. Generally, effects of the visual identifiers are coordinated to begin at a next subsequent time window. In this manner, visual effects are not uncoordinated, e.g., due to vehicles being plugged into charging devices at different times relative to the time windows.

The initialization process may not be identical for each vehicle or charging device. As shown in FIG. 4, connection of the first vehicle to the charger 100a occurs at time t₁, which is during a first time window w₀. The initialization process upon connection of the first vehicle to the charging device 100a takes approximately 10 seconds, during which time the visual identifier 108 flashes in a first color, e.g., white, with a first speed. In the example shown, the flashing in this first color occurs every two seconds. As illustrated, the visual identifier 108 of the charging device 100a ramps up and down in intensity, beginning initially at the first time window occurring immediately after a time window w₀ (i.e., time window w₁) in which the first vehicle is plugged into the first charging device 100a. Initialization takes approximately eight (8) seconds, such that charging of the vehicle begins at time t3, during time window w2. At the next subsequent time window w3, the effect provided by visual indicator 108 may change to indicate charging, changing to a more slowly “pulsing” green color. More specifically, the brightness of the green color of the visual identifier 108 increases to a maximum and then decreases to a minimum repeatedly, with each cycle taking four (4) seconds. The pulsing of the green light of the first charging device may continue until charging is completed (not shown in FIG. 4).

As shown in FIG. 4, connection of the second vehicle to the second charging device 100b occurs at time t₂, which is during time window w₁. The charging system 112 may begin initializing immediately, as with the first vehicle, and with the initializing/pulsing effect of the visual identifier 108 of the second charging device 100b beginning with the onset of the next subsequent time window w₂. Initialization of the charging device 100b continues for approximately 11 seconds until time t₄, when the charging device 100b begins charging the second vehicle. It should be noted that while the charging device 100b begins charging the vehicle at time t₄, the visual identifier 108 does not begin the relatively slower pulse effect and green color until the subsequent time window w₅. Accordingly, the pulsing/flashing of both visual identifiers 108 of the charging devices 100a, 100b are synchronized. Moreover, while the pulsing effect of the initialization lighting is different from that employed during vehicle charging (i.e., relatively quicker pulsing blue light, compared with relatively slower pulsing green light), the start/stop of the pulsing effects of each are synchronized.

As mentioned above, charging system 112 may employ visual identifiers 108 of charging device(s) to provide information to vehicles or customers regarding charging devices 100 or other components of the system 112, and/or the vehicles being charged by the system 112. The system 112 may also, in response to a notification or request from a vehicle approaching charging system 112, select a charging device 100 from amongst a plurality of available charging devices in the system 112, and communicate the selection to the approaching vehicle. Charging system 112 may select a charging device 100 based upon any number of factors or characteristics that is convenient. In some examples, characteristics of vehicle(s) using the charging system 112 or approaching the charging system 112 may influence charging device selection. Alternatively, or in addition, characteristics of the charging system 112 or components thereof may be used to influence selection of a charging device 100. These and other factors that may be used by a charging system will be discussed in the context of examples below. Generally, the controllers 118/120 and/or central office 122 may know a state-of-charge (SOC) and other characteristics of vehicles 150 using charging system(s) 112. Accordingly, such vehicle-specific information may be used to determine an appropriate charging device 100 for vehicles approaching a charging system 112, e.g., in an effort to match vehicles 150 with a charging device 100 that will yield them the fastest charge. Additionally, vehicles 150 may be assigned to charging devices 100 based upon an efficient charging profile for the system 112, thereby increasing throughput of vehicles 150 in the system 112. In one example, the controller 120 and/or central office 122 may be in communication with vehicles 150 and may thereby know location and speed of an arriving vehicle 150 from vehicle telematics and/or GPS, the SOC as a percentage, and information regarding available charging devices 100 and/or sources 116. Accordingly, an appropriate charging device 100 may be determined, and a visual identifier 108 of the determined charging device 100 may be activated as the vehicle 150 approaches the system 112. This improves throughput of vehicles in the system 112, and also provides customer peace of mind that they are plugging into the charging device 100 that is optimized for their vehicle. Additionally, the controller 120 and/or central office 122 may balance an electrical load of the system 112, chargers 100, and/or sources 116.

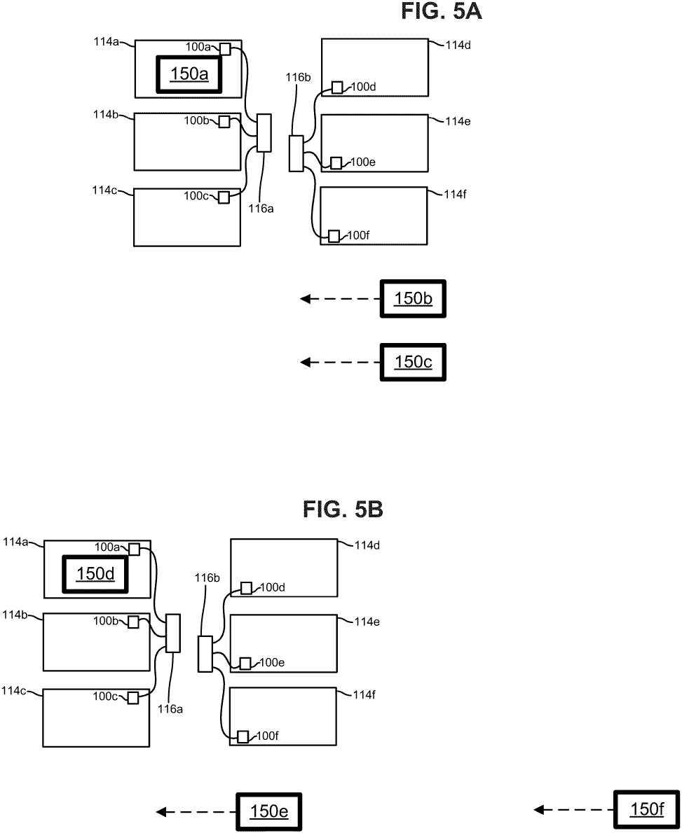

Referring now to FIG. 5A, the charging system 112 is illustrated in a first example illustrating the use of one or more vehicle-based factors to select an appropriate charging device 100 of the system 112 for approaching vehicle(s). More specifically, the system 112, as noted above, includes six charging devices 100 and two sources 116, with each of the sources 116 supplying electrical power to three of the charging devices 100. In the example in FIG. 5A, initially a vehicle 150a is plugged into charging device 100 and is at 90% SOC when two additional vehicles 150b and 150c arrive at the system 112. Both of the arriving vehicles 150b and 150c have a relatively low SOC, e.g., below 20%. Based on an expectation that the vehicle 150a will soon depart the system 112 based upon its nearly full SOC, the controllers 116 and/or central office 122 may divide the two arriving vehicles 150b and 150c between the sources 116a, 116b, thereby equally dividing total charging capacity between the two vehicles 150b and 150c. For example, controllers 118 may activate the visual identifiers 108 of charging devices 100c and 100d for the arriving vehicles 150b and 150c, respectively, e.g., by communicating with controllers 120 of the chargers 100c/100d. In this manner, each of the arriving vehicles 150b and 150c can drive straight to the identified charging devices 100c/100d, and need not drive around the site, etc.

Optionally, the visual identifiers 108 may be activated in a manner specific to each of the arriving vehicles 150b and 150c, e.g., each with a different color that is communicated to the vehicles 150b and 150c, respectively. For example, to the extent the vehicles 150b and 150c are arriving simultaneously, the first arriving vehicle 150b may be told (e.g., via a display or screen of the vehicle 150b) to look for an orange blinking visual identifier 108. The second arriving vehicle 150c, by contrast, may be told to look for a purple blinking visual identifier 108.

By sending the arriving vehicles 150b and 150c to charging devices 100 linked to different sources 116a and 116b, the system 112 ensures that one of the arriving vehicles is able to use its own source 116 and to charge as fast as possible. Additionally, the second vehicle will very soon have the full charging power of the other source 116a available based upon the expectation that the vehicle 150a will be departing the system 112 shortly. Moreover, the vehicle 150a may also be prompted with a notification, e.g., by way of the visual identifier 108 of the charging device 100a, that the vehicle 150a is ready to continue on its trip.

Turning now to FIG. 5B, the use of charging device or system-based factors to identify an appropriate charging device for a vehicle are illustrated and described in further detail. Typically, it may be desirable to distribute incoming vehicles to charging devices 100 of the system in an effort to balance power demand (e.g., kW) of the system 112 with a desire to reduce utility costs. At the outset, charging power required for a vehicle may vary depending on a state of charge of the vehicle. Vehicles having a greater state of charge may require less power input for charging. More particularly, a vehicle approaching a maximum state of charge level may require less power input from a charging device 100 to complete charging, and moreover may require less time/energy input to become fully charged or substantially so. The system 112 may take a vehicle’s state of charge into account when determining a desired charging device 100 for a vehicle, as described further below.

In one example, in an effort to respond to a demand response event, or simply as a way to reduce utility costs of the system 112, arriving vehicles may be directed to charging devices 100 of a single or shared source 116. For example, as illustrated in FIG. 5B a vehicle 150d is being charged by the system 112 via charging device 100a and, by extension, source 116a. The vehicle 150d has a SOC of 90%, and as a result is consuming a relatively low amount of power in relation to an overall capability of the source 116a. In the example illustrated, the vehicle 150d is consuming 48 kilowatts (kW), with the source 116a (and, for that matter, source 116b) having a capability to deliver 300 kW. An arriving vehicle 150e having a relatively low SOC (e.g., below 20%) may be directed to a charging device on the same source 116a, e.g., charging device 100b, (e.g., by blinking the visual identifier 108 thereof) and charges at 150 kW. The vehicle 150d soon leaves, and as a result the vehicle 150e continues to charge at 150 kW. Another vehicle 150f arrives thereafter and is directed to charging device 100c and charges the vehicle 150f at 150 kW. Accordingly, the total demand of the system 112 is 300 kW. In contrast, in the example above where vehicles are divided between different sources 116a and 116b, total demand may be 600 kW. The approach to distribute vehicles 150e and 150f to a same source 116a may be useful particularly where the vehicles 150d and 150f have a relatively higher SOC such that there would be minimal benefit, if any, to sending the vehicles 150e and 150f to different sources 116. In this manner, the customer experience is not harmed in a noticeable or meaningful way despite the relatively lower charging power being delivered to the vehicles 150e and 150f.

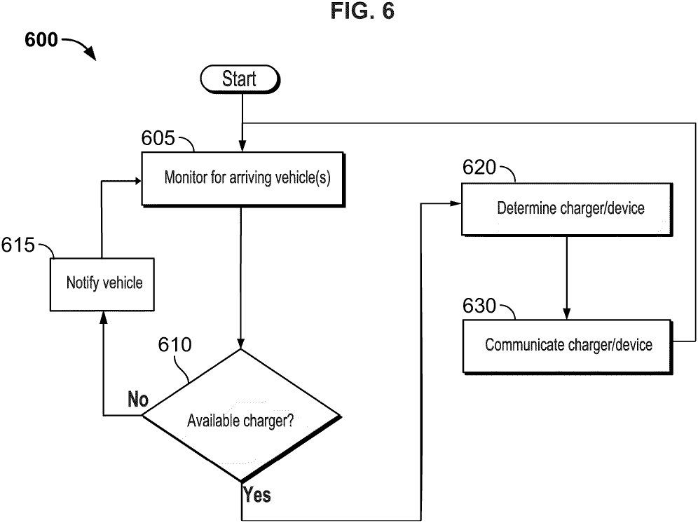

Referring now to FIG. 6, an example process 600 of determining a charging device from a plurality of charging devices in a charging system is illustrated and described in further detail. Process 600 may begin at block 605, where a charging system, e.g., by way of a controller or central office, may generally monitor for vehicles arriving at a charging system. A customer in a vehicle may, for example, send a notification indicating they are seeking a charging system. In other examples, vehicle telematics, GPS radio, or the like may be used to automatically notify a charging system 112 that the vehicle is nearing a charging system 112. In an example, a vehicle user may identify or select a location or charging system 112 for charging, e.g., by way of an application on the vehicle, a mobile device, or the like. In response, the application and/or vehicle may send a notification to the central office 122 and/or controllers 118. In another example, the vehicle can provide location updates to the controller(s) 118, and when the vehicle is near a charging system 112 (e.g., within a certain threshold distance), the controller(s) 118 will determine that the vehicle is approaching the charging system 112. In at least some examples, the notification may simply be a reported location of the vehicle, and the controller(s) 118 determining that the location of the vehicle is within a predetermined distance of the charging system 112. Upon receipt of a notification that a vehicle is arriving or near a charging station, process 600 may proceed to block 610.

At block 610, process 600 may query whether a charger or charging device is available to charge the approaching vehicle. Where process 600 determines that no chargers are available, e.g., due to the charging device(s) of a charging system being inoperative or otherwise unavailable, process 600 may proceed to block 615. At block 615, a notification is sent to the approaching vehicle to indicate that no charging devices or chargers are available. In the example where there are no chargers available, the vehicle may be notified of the lack of charging devices to allow the vehicle to seek other charging systems. In this manner, the vehicle may be re-routed to another charging system, without traveling to the charging system where there are no available chargers.

Alternatively, where process 600 determines that at least one charger is available, process 600 may proceed to block 620. At block 620, process 600 may determine a charger for use by the approaching vehicle. Where multiple chargers are available, one charger may be selected for the vehicle based upon vehicle-specific or system-specific factors, e.g., as described above. In some example approaches, a state of charge of the approaching vehicle may be used to determine an appropriate or desired charger. For example, where an approaching vehicle has a relatively low SOC, it may be expected that the vehicle will benefit from a greater electrical power supply from a charger and, by extension, a source of electrical power for the charger. In contrast, vehicles with a relatively higher SOC may be expected to use a lower level of power or otherwise consume less electrical energy to recharge. In some examples, a system 112 may use a vehicle SOC level or percentage to determine an expected power consumption rate. System 112 may also compare a vehicle SOC to that of other vehicles present in the system 112, e.g., which are presently recharging or are arriving for recharging at the system 112. For example, as discussed above, where two vehicles are arriving at a charging system 112, each with a relatively low SOC, it may be useful to divide the vehicles between separate sources 116 in an effort to maximize available power. Alternatively, where the arriving vehicles are at a relatively higher SOC, e.g., greater than 60%, it may be beneficial for overall power consumption of the charging system 112 to assign the vehicles to chargers or charging devices of a same source 116.

As also described above, a charging capacity of a source or electrical charging device supplying electrical power to a plurality of chargers may be used to determine a desired charger/charging device for an arriving vehicle. The information regarding charging capacity may be contextualized with vehicle-specific information, e.g., a vehicle SOC, or may be relied upon in the absence of vehicle-specific information, e.g., where vehicle-specific information is not available. In the example above, two incoming vehicles with a relatively higher SOC are assigned to a same source 116a on the basis of their SOC being relatively high, such that charging power supplied to the vehicle does not necessarily need to be maximized and an opportunity exists to preserve overall flexibility of the charging system 112 to accomodate additional charging demands that may arise. For example, assigning the two vehicles to a single source 116a/116b may preserve greater ability to charge additional vehicles that may arrive, particularly if greater charging needs such as multiple vehicles or a vehicle with a relatively low SOC arrives. Merely as one example, if a third vehicle arriving had a relatively low SOC, the other source 116b would remain available to charge the newly arriving vehicle 150 with relatively low SOC.

Upon determination of a charger or charging device 100 at block 620, process 600 may proceed to block 630. At block 630, in response to the notification of the approaching vehicle, information identifying one of the plurality of chargers may be provided to the vehicle. For example, as noted above a visual identifier may be activated at the determined charger or charging device, thereby drawing visual attention to the charging device. Further, the visual identifier may be activated in a manner that is individualized or specific to a vehicle, e.g., by way of a selected color, pulsing, flashing, movement, or the like. While the example illustrations herein are generally directed to activation of a visual identifier 108 at a charging device 100, in some example approaches additional notifications, e.g., via a mobile device, application or screen of a vehicle, the screen 111 of charger 100 or the like, may be provided in addition to the visual identifier 108. Process 600 may then proceed back to block 605 to monitor for additional vehicles. Accordingly, to the extent additional vehicles are determined to be approaching the charging system 112, appropriate charging devices or chargers may be identified to the additional vehicles using a vehicle-specific approach, e.g., with vehicle-specific colors, movement, pulsing/flashing patterns, etc. Although examples discussed with reference to process 600 above monitor for vehicles arriving at, or nearby to, a charging system (process 605), in other examples, in addition, this monitoring may occur before a vehicle arrives or is nearby to the charging system. For example, the monitoring of one or more vehicles may be initiated by the user of a vehicle entering the charging system location into their GPS, or when the vehicle otherwise indicates that it may arrive at the charging station at a particular time. In such examples, process 605 may monitor for other vehicles scheduled to arrive at or around the same time, and begin a preliminary determination of charger/device (process 620) in advance of the vehicles actually arriving.

As noted above, in some cases multiple visual identifiers 108 in a given charging system 112 may be activated at a same time. For example, two different charging devices 100 may have their respective visual identifiers 108 activated with a different color, each color specific to respective approaching vehicles. In another example, multiple vehicles may be charged by the system 112 at a given time via respective different charging devices 100, with the charging devices 100 having their visual identifiers 108 activated with a same color and/or pulsing/movement, e.g., a green color with a relatively slow pulsing effect. To the extent the activation of multiple visual identifiers 108 in the system 112 employ a similar movement or pulsing effect, these effects may be coordinated, e.g., via the use of time windows as discussed above in connection with FIG. 4. Accordingly, a delay in activation of a visual identifier at block 630 may be implemented to coordinate with additional visual identifier(s) already activates in the charging system 112.

Generally, the above example systems and methods may facilitate use of a vertical integration of a fleet of vehicles, e.g., of a single brand or group, allowing use of vehicle-specific attributes (e.g., state of charge, proximity to charger, etc.) in determining appropriate or desired charging devices to be identified to a vehicle. System characteristics such as charging capacity may also be relied upon to determine a charging device capable of providing a best user/customer experience. Further, example visual identifiers such as the visual identifier 108 may be used to communicate with customers in a relatively simple, user-friendly manner, and requiring little technical knowledge on the part of the consumer to maximize efficient use of a charging system.

The foregoing description includes exemplary embodiments in accordance with the present disclosure. These examples are provided for purposes of illustration only, and not for purposes of limitation. It will be understood that the present disclosure may be implemented in forms different from those explicitly described and depicted herein and that various modifications, optimizations, and variations may be implemented by a person of ordinary skill in the present art, consistent with the following claims.

What is claimed is:

1. A method, comprising:
receiving a notification of a vehicle to be charged by a charging station comprising a plurality of chargers;
in response to the notification, determining a first one of the plurality of chargers to be used to charge the vehicle; and
visually communicating information identifying the first one of the plurality of chargers to be used.

2. The method of claim 1, further comprising determining the first one of the plurality of chargers based upon a state of charge of the vehicle.

3. The method of claim 2, wherein the first one of the plurality of chargers is determined based upon a comparison of the state of charge of the vehicle to a state of charge of an additional vehicle.

4. The method of claim 1, further comprising determining the first one of the plurality of chargers based upon a charging capacity of a first charging source supplying electrical power to a first subset of the plurality of chargers.

5. The method of claim 4, wherein the first one of the plurality of chargers is determined based upon a comparison of the charging capacity of the first charging source with a charging capacity of a second charging source supplying electrical power to a second subset of the plurality of chargers, exclusive of the first subset of the plurality of chargers.

6. The method of claim 1, wherein visually communicating information identifying the first one of the plurality of chargers to the user of the vehicle includes activating a first visual identifier at the one of the plurality of chargers, wherein the first visual identifier includes a first color associated to the vehicle.

7. The method of claim 6, wherein visually communicating information identifying the first one of the plurality of chargers to the user of the vehicle further comprises the vehicle displaying the first color to the user on a vehicle display.

8. The method of claim 6, further comprising visually communicating information identifying a second one of the plurality of chargers to an additional vehicle approaching the charging station with a second visual identifier comprising a second color distinct from the first color.

9. The method of claim 6, further comprising communicating a second one of the plurality of chargers to an additional vehicle approaching the charging station with a second visual identifier, wherein the first visual identifier and the second visual identifier each include a variation synchronized with a time window.

10. A system for charging vehicles via a plurality of chargers, the system comprising:
a processor, configured to:
receive a notification of a vehicle to be charged by a charging station comprising the plurality of chargers; and
in response to the notification, determine a first one of the plurality of chargers for charging the vehicle; and
a first visual identifier located at a first one of the plurality of chargers, wherein the processor is configured to activate the first visual identifier to communicate the first one of the plurality of chargers to be used.

11. The system of claim 10, wherein the processor is configured to determine the first one of the plurality of chargers based upon a state of charge of the vehicle.

12. The system of claim 11, wherein the processor is configured to determine the first one of the plurality of chargers based upon a comparison of the state of charge of the vehicle to a state of charge of an additional vehicle.

13. The system of claim 10, wherein the processor is configured to determine the first one of the plurality of chargers based upon a charging capacity of a first charging source supplying electrical power to a first subset of the plurality of chargers.

14. The system of claim 13, wherein the processor is configured to determine the first one of the plurality of chargers based upon a comparison of the charging capacity of the first charging source with a charging capacity of a second charging source supplying electrical power to a second subset of the plurality of chargers, exclusive of the first subset of the plurality of chargers.

15. The system of claim 10, wherein the first visual identifier includes a first color associated to the vehicle, and wherein the system comprises a second visual identifier located at a second one of the plurality of chargers, the second visual identifier comprising a second color distinct from the first color.

16. The system of claim 10, wherein the first visual identifier includes a plurality of selectively activated colors or movement patterns.

17. The system of claim 16, wherein the processor is configured to communicate one of a plurality of distinct charging statuses to the vehicle via the first visual identifier, the plurality of distinct charging statuses each associated with a different one of the plurality of selectively activated colors or movement patterns.

18. A system for charging vehicles via a plurality of chargers, the system comprising:
a processor, configured to:
receive a notification of a vehicle to be charged by a charging station comprising the plurality of chargers; and
in response to the notification, determine a first one of the plurality of chargers for charging the vehicle;
a first visual identifier located at a first one of the plurality of chargers; and
a second visual identifier located at a second one of the plurality of chargers;
wherein the processor is configured to activate one of the first visual identifier or the second visual identifier to the vehicle to identify the first one of the plurality of chargers to be used.

19. The system of claim 18, wherein the first and second visual identifiers each include a plurality of selectively activated colors or movement patterns.

20. The system of claim 19, wherein the processor is configured to communicate one of a plurality of distinct charging statuses of the first one of the plurality of chargers and the second one of the plurality of chargers via the first visual identifier and the second visual identifier, respectively, wherein the plurality of distinct charging statuses are each associated with a different one of the plurality of selectively activated colors or movement patterns.
